(19) United States
(12) Patent Application Publication
(10) Pub. No.: US 2016/0351136 A1
(43) Pub. Date: Dec. 1, 2016

(54) LIQUID CRYSTAL DISPLAY PANEL AND DEVICE THEREOF

(71) Applicant: SHENZHEN CHINA STAR OPTOELECTRONICS TECHNOLOGY CO. LTD., Shenzhen, Guangdong (CN)

(72) Inventors: Tao HE, Shenzhen, Guangdong (CN); Yuyeh CHEN, Shenzhen, Guangdong (CN)

(21) Appl. No.: 14/771,031

(22) PCT Filed: Jul. 16, 2015
(86) PCT No.: PCT/CN2015/084227

§ 371 Date: Aug. 27, 2015

(30) Foreign Application Priority Data
May 20, 2015 (CN) 201510259661.0

(51) Int. Cl. G09G 3/36; G02F 1/1368; G09G 3/00; G02F 1/1362

(52) U.S. Cl. CPC G09G 3/3607; G02F 1/136286; G02F 1/1368; G09G 3/003; G09G 3/3618; G09G 3/3677; G09G 3/3688; G02F 2201/52; G09G 2320/0209; G09G 2320/0247

(57) ABSTRACT

An LCD panel and an LCD device are provided. The LCD panel includes all pixels respectively defined by a plurality of data lines and a plurality of the scanning lines to form a plurality of pixel columns and a plurality of pixel rows. All of the pixels in each column have the same color, and the two adjacent pixels in each pixel unit have opposite polarities. The pixels having the same color in two adjacent pixel units have opposite polarities, and each of the data lines is connected with the pixels with the same polarity.

### BACKGROUND OF THE INVENTION

Field of the Invention

The present invention relates to liquid crystal display (LCD) technology, and more particularly to an LCD panel and device thereof.

Description of Prior Art

Along with the continuous development of LCD devices, one of the main research directions in LCD panel has become how to let LCD panel have a better display performance.

FIG. 1 is a schematic structural view according to a conventional LCD panel. The LCD panel 10 includes data lines 11, scanning lines 12, and a plurality of pixel rows and pixel columns defined by the data lines 11 and the scanning lines 12. The plurality of data lines 11 are configured for inputting data signals to a plurality of pixel rows, and the plurality of scanning lines 12 are configured for inputting scanning signal lines to a plurality of pixel columns. All pixels can be displayed on a screen in accordance with the corresponding data signals and the corresponding scanning signals. In the LCD panel, a scan line 12 provides a scanning signal to the pixels of a row, and a data line 11 provides data signals to the pixels of a column which have the same color. To prevent the liquid crystal molecules from the occurrence of a polarization phenomenon, a polarity reversion is operated for each pixel after each pixel has been used to display one frame data or several frame data. For example, the red pixels having positive polarity are reversed to the red pixels having negative polarity.

As shown in FIG. 1, the pixels in each column of one picture frame have the same color and polarity, for example, pixels in the first column are red pixels with positive polarity, and two adjacent pixels in the same row have opposite polarities, e.g in the first row, the red pixel with positive polarity R+ and the green pixel with negative polarity G−, the blue pixel with positive polarity B+ and the red pixel with negative polarity R−, the green pixel with positive polarity G+ and the blue pixel negative polarity B−.

However, the common voltage in an LCD panel which has the aforementioned structure is prone to coupling occurrence while the polarity is alternating in the column direction, and problems such as a screen flicker and a horizontal crosstalk are prone to being generated.

Therefore, there is a need to provide an LCD panel and an LCD device in order to solve the problems of the prior art.

### SUMMARY OF THE INVENTION

The objective of the present invention is to provide an LCD panel and an LCD device to solve the technical problems in the prior art, in which a screen flicker and a horizontal crosstalk easily emerge when performing a three-dimensional display.

To solve the foregoing problems, the present invention provides an LCD panel, which comprises:
a plurality of data lines configured for transmitting data signals;
a plurality of scanning lines configured for transmitting scanning signals; and
a plurality of pixel units, each of the pixel units including a plurality of pixels, which have colors including red, green, and blue;
all of the pixels defined by the data lines forming a plurality of pixel columns, or all of the pixels defined by the scanning lines forming a plurality of pixel rows;
wherein all of the pixels in each column have the same color, the pixels with the same color in two adjacent pixel units have opposite polarities, the two adjacent pixels in each pixel unit have opposite polarities, and each of the data lines is connected with the pixels having the same polarity;
when the LCD panel performs a two-dimensional display, a progressive scan for the scanning lines is enabled;
when the LCD panel performs a three-dimensional display, a sequential scan based on orders of groups for the scanning lines being enabled, in which the group for the scanning lines representing a plurality of adjacent scan lines at the rows numbering 2k or a plurality of adjacent scan lines at the rows numbering 2k+1, where k is a positive integer.

In the LCD panel of the present invention, the group of the scanning lines represents 2-4 adjacent scan lines at the rows numbering 2k or 2-4 adjacent scan lines at the rows numbering 2k+1.

In the LCD panel of the present invention, a refresh rate of the LCD panel is set between 120 Hz and 240 Hz

In the LCD panel of the present invention, the LCD panel further comprises a gate driver chip and a source driver chip, the gate driver chip is connected with the scan lines, through which scan signals are inputted to the pixels for each row; the source driver chip is connected with the data lines, through which data signals are inputted to the pixels for each column.

In the LCD panel of the present invention, the pixel may further comprise a thin film transistor, the scanning line is connected with a control terminal of the thin film transistor of the pixel and the data line is connected with an input terminal of the thin film transistor.

To solve the foregoing problems, the present invention provides an LCD panel, which comprises:
a plurality of data lines configured for transmitting data signals;
a plurality of scanning lines configured for transmitting scanning signals; and
a plurality of pixel units, each of the pixel units including a plurality of pixels, which have colors including red, green, and blue;
all of the pixels defined by the data lines forming a plurality of pixel columns, or all of the pixels defined by the scanning lines forming a plurality of pixel rows;
wherein all of the pixels in each column have the same color, the pixels with the same color in two adjacent pixel units have opposite polarities, the two adjacent pixels in each pixel unit have opposite polarities, and each of the data lines is connected with the pixels having the same polarity.

In the LCD panel of the present invention, a progressive scan for the scanning lines is enabled when the LCD panel performs a two-dimensional display.

In the LCD panel of the present invention, when the LCD panel performs a three-dimensional display, a sequential scan based on orders of groups for the scanning lines is enabled, in which the group for the scanning lines represents a plurality of adjacent scan lines at the row numbering 2k or a plurality of adjacent scan lines at the row numbering 2k+1, where k is a positive integer.

In the LCD panel of the present invention, the group of the scanning lines represents 2-4 adjacent scan lines at the row numbering 2k or 2-4 adjacent scan lines at the row numbering 2k+1.

In the LCD panel of the present invention, a refresh rate of the LCD panel is set between 120 Hz and 240 Hz

The present invention further provides an LCD device, the LCD device comprises:
a backlight module; and
an LCD panel comprising:
   a plurality of data lines configured for transmitting data signals;
   a plurality of scanning lines configured for transmitting scanning signals; and
   a plurality of pixel units, each of the pixel units including a plurality of pixels, which have colors including red, green, and blue;
all of the pixels defined by the data lines forming a plurality of pixel columns, or all of the pixels defined by the scanning lines forming a plurality of pixel rows;
wherein all of the pixels in each column have the same color, the pixels with the same color in two adjacent pixel units have opposite polarities, the two adjacent pixels in each pixel unit have opposite polarities, and each of the data lines is connected with the pixels having the same polarity.

In the LCD device of the present invention, a progressive scan for the scanning lines is enabled when the LCD panel performs a two-dimensional display.

In the LCD device of the present invention, when the LCD panel performs a three-dimensional display, a sequential scan based on orders of groups for the scanning lines is enabled, in which the group for the scanning lines represents a plurality of adjacent scan lines at the row numbering 2k or a plurality of adjacent scan lines at the row numbering 2k+1, where k is a positive integer.

In the LCD device of the present invention, the group of the scanning lines represents 2-4 adjacent scan lines at the row numbering 2k or 2-4 adjacent scan lines at the row numbering 2k+1.

In the LCD device of the present invention, a refresh rate of the LCD panel is set between 120 Hz and 240 Hz.

The LCD panel and LCD device of the present invention can avoid the problems such as crosstalk, flicker and the like and thereby improve the display performance by means of improving the pixel arrangement structure of the panel.

### BRIEF DESCRIPTION OF THE DRAWINGS

FIG. 1 is a schematic structural view according to a conventional LCD panel.

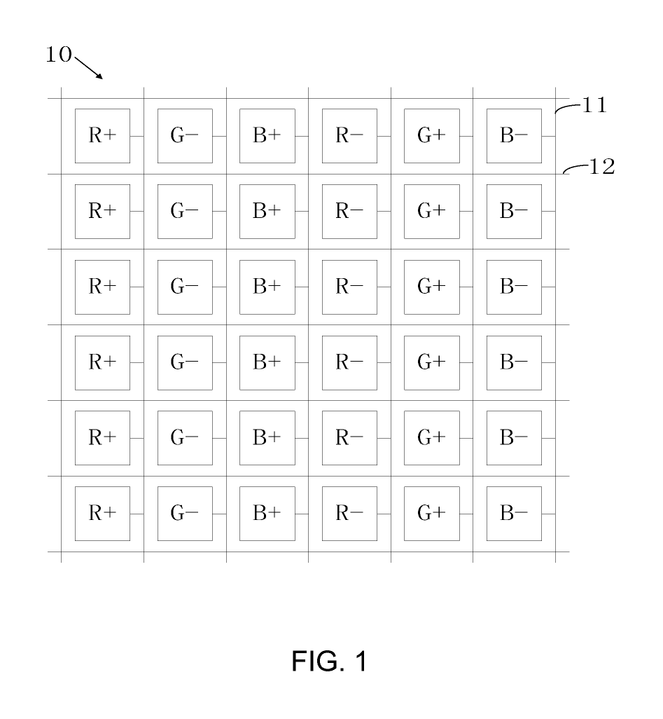

FIG. 2 is a schematic structural view according to one embodiment of an LCD panel of the present invention.

### DETAILED DESCRIPTION OF THE INVENTION

The preferred embodiments of the present invention will be detailed in the following in combination with the accompanying drawings. Spatially relative terms mentioned herein, such as “above”, “beneath”, “front”, “back”, “left”, “right”, “inner”, “outer”, “lateral”, and the like may be used to describe one element's relationship to another element(s) as illustrated in the figures. Furthermore, the articles “a” and “an” as used in this specification and the appended claims should generally be construed to mean “one or multiple”, unless specified or clear from context to be directed to be a singular form. The drawings are drawn schematically and the same reference numbers are used to indicate the same or similar components throughout the drawings.

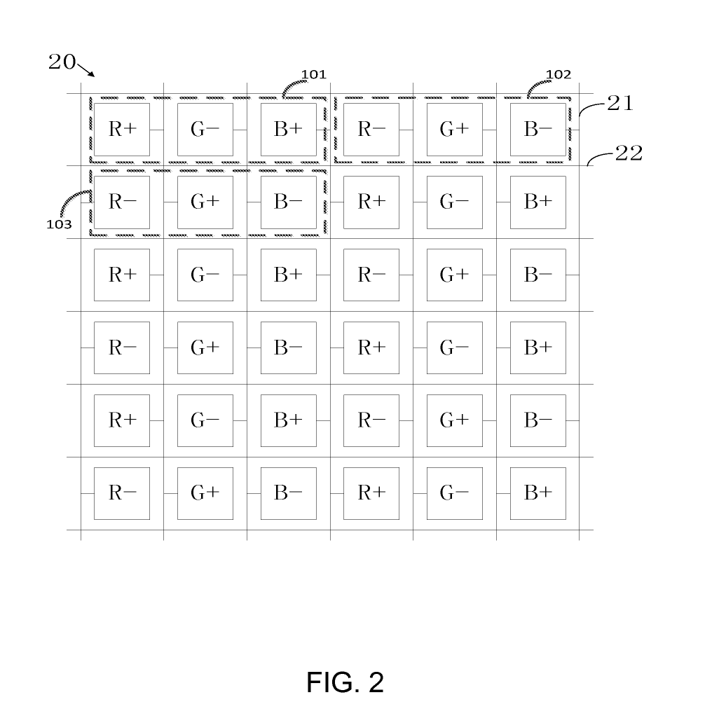

Refer to FIG. 2, which is a schematic structural view according to one embodiment of an LCD panel of the present invention.

The LCD panel of the present invention 20 includes an array substrate, and the array substrate includes a plurality of data lines 21, a plurality of scan lines 22, and a plurality of pixel units. Each of the pixel units includes a plurality of pixels, which have colors including red, green, and blue, but certainly may also include yellow or white, and the present invention takes only an exemplary pixel having a red, green, blue arrangement order in the pixel unit for illustrative purposes, but is not intended to limit the scope of the present invention.

All of the pixels defined by a plurality of data lines form a plurality of pixel columns, or all of the pixels defined by a plurality of the scanning lines form a plurality of pixel rows, in which the data lines can input data signals to the plurality of pixel rows and the scanning lines can input scanning signal lines to the plurality of pixel columns. Accordingly, the pixel units can display pictures in accordance with the corresponding data signals and the corresponding scanning signals.

As shown in FIG. 2, all pixels in each column have the same color, and the pixels with the same color in two adjacent pixel units have opposite polarities. That is, the two adjacent pixels in an identical column have opposite polarities, and the two adjacent pixels in an identical row also have opposite polarities. For example, the red pixel has a positive polarity R+ in a pixel unit 101 while the red pixel has a negative polarity R− in a pixel unit 102; the green pixel has a positive polarity G+ in a pixel unit 101 while the green pixel has a negative polarity G− in a pixel unit 102; the blue pixel has a positive polarity B+ in a pixel unit 101 while the blue pixel has a negative polarity B− in a pixel unit 102. Each of the data lines is connected with the pixels with the same polarity, for example, a first data line counted from left to right is connected with a red pixel having a negative polarity R−, and a second data line is connected with a red pixel having a positive polarity R+ and a green pixel having a positive polarity G+.

Preferably, when the LCD panel 20 performs a two-dimensional display, the refresh rate of the screen display is lower, and thus a progressive scan can be enabled for all the scanning lines 22 of the LCD panel 20 to ensure the picture display quality of the two dimensional display.

Preferably, when the LCD panel 20 performs a three-dimensional display, it is necessary to use with a 3D (three-dimensional) shutter glasses and simultaneously display a left-eye picture and a right-eye picture, in other words, a display time consumed for displaying one frame in the two-dimensional display requires displaying two frames in the three-dimensional display. Thus, the refresh rate of the screen display is higher, and the refresh rate of the LCD panel 20 may be set between 120 Hz and 240 Hz. At this moment, a sequential scan based on orders of groups for the scanning lines 22 is enabled to ensure the data line 21 which can allow the pixel unit to be fully charged by using the data signal. The group of the scanning lines represents a plurality of adjacent scan lines at the row numbering 2k (the even row) or a plurality of adjacent scan lines at the row numbering 2k+1 (the odd row), where k is a positive integer. For example, the group of the scanning lines may represent 2-4 adjacent scan lines at the row numbering 2k (the even row), or 2-4 adjacent scan lines at the row numbering 2k+1 (the odd row).

For example, pixels in a first row and pixels in a third row are identical, and the polarity of the pixels in the two rows is also identical. In other words, the same data signal can be inputted, and a scanning operation can be performed on the scanning lines for the two rows. Accordingly, the charging time is reduced, and the pixel units are allowed to be fully charged.

Because each data line is connected with pixels having a positive polarity and pixels having a negative polarity, and the number of the pixels having a positive polarity and the number of the pixels having a negative polarity are equal. Such a structure can cause the coupling effect between the data lines and the common voltage to cancel each other out, thereby effectively preventing the offset of the common voltage, and the problems such as crosstalk, flicker and the like can be avoided. As a result, the LCD panel of the present invention has a better display performance than the conventional LCD panel.

The LCD panel may further include a color filter substrate, which may include a black matrix and a common electrode.

The pixel may further include a thin film transistor, and the scanning line is connected with a control terminal of the thin film transistor of the pixel, and the data line is connected with an input terminal of the thin film transistor.

The LCD panel may further include a gate driver chip and a source driver chip. The gate driver chip is connected with the scan lines, and scan signals are inputted to the pixels for each row through the scan lines. The source driver chip is connected with the data lines, and data signals are inputted to the pixels for each column through the data lines.

The present invention further provides an LCD device including a backlight module and an LCD panel, and the LCD panel of the present invention includes an array substrate, which comprises a plurality of data lines 21, a plurality of scanning lines 22, and a plurality of pixel units. Each of the pixel units includes a plurality of pixels, which have colors including red, green, and blue, but certainly may also include yellow or white, and the present invention takes only an exemplary pixel having a red, green, blue arrangement order in the pixel unit for illustrative purposes but is not intended to limit the scope of the present invention.

All of the pixels defined by a plurality of data lines form a plurality of pixel columns, or all of the pixels defined by a plurality of the scanning lines form a plurality of pixel rows, in which the data lines can input data signals to the plurality of pixel rows and the scanning lines can input scanning signal lines to the plurality of pixel columns. Accordingly, the pixel units can display pictures in accordance with the corresponding data signals and the corresponding scanning signals.

As shown in FIG. 2, all pixels in each column have the same color, and the pixels having the same color in two adjacent pixel units have opposite polarities. That is, the two adjacent pixels in an identical column have opposite polarities, and the two adjacent pixels in an identical row also have opposite polarities. For example, the red pixel has a positive polarity R+ in a pixel unit 101 while the red pixel has a negative polarity R− in a pixel unit 102; the green pixel has a positive polarity G+ in a pixel unit 101 while the green pixel has a negative polarity G− in a pixel unit 102; the blue pixel has a positive polarity B+ in a pixel unit 101 while the blue pixel has a negative polarity B− in a pixel unit 102. Each of the data lines is connected with the pixels with the same polarity, for example, a first data line counted from left to right is connected with a red pixel having a negative polarity R−, and a second data line is connected with a red pixel having a positive polarity R+ and a green pixel having a positive polarity G+.

Preferably, when the LCD panel 20 performs a two-dimensional display, the refresh rate of the screen display is lower, and thus a progressive scan can be enabled for all the scanning lines 22 of the LCD panel 20 to ensure the picture display quality of the two dimensional display.

Preferably, when the LCD panel 20 performs a three-dimensional display, it is necessary to use with a 3D (three-dimensional) shutter glasses and simultaneously display a left-eye picture and a right-eye picture, in other words, a display time consumed for displaying one frame in the two-dimensional display requires displaying two frames in the three-dimensional display. Thus, the refresh rate of the screen display is higher, and the refresh rate of the LCD panel 20 may be set between 120 Hz and 240 Hz. At this moment, a sequential scan based on orders of groups for the scanning lines 22 is enabled to ensure the data line 21 which can allow the pixel unit to be fully charged by using the data signal. The group of the scanning lines represents a plurality of adjacent scan lines at the row numbering 2k (the even row) or a plurality of adjacent scan lines at the row numbering 2k+1 (the odd row), where k is a positive integer. For example, the group of the scanning lines may represent 2-4 adjacent scan lines at the row numbering 2k (the even row) or 2-4 adjacent scan lines at the row numbering 2k+1 (the odd row).

For example, pixels in a first row and pixels in a third row are identical, and the polarity of the pixels in the two rows is also identical. In other words, the same data signal can be inputted, and a scanning operation can be performed on the scanning lines for the two rows. Accordingly, the charging time is reduced, and the pixel units are allowed to be fully charged.

Because each data line is connected with pixels having a positive polarity and pixels having a negative polarity, and the number of the pixels having a positive polarity and the number of the pixels having a negative polarity are equal. Such a structure can cause the coupling effect between the data lines and the common voltage to cancel each other out, thereby effectively preventing the offset of the common voltage, and the problems such as crosstalk, flicker and the like can be avoided. As a result, the LCD panel of the present invention has a better display performance than the conventional LCD panel.

The LCD panel may further include a color filter substrate, which may include a black matrix and a common electrode.

The pixel may further include a thin film transistor, and the scanning line is connected with a control terminal of the thin film transistor of the pixel, and the data line is connected with an input terminal of the thin film transistor.

The LCD panel may further include a gate driver chip and a source driver chip. The gate driver chip is connected with the scan lines, and scan signals are inputted to the pixels for each row through the scan lines. The source driver chip is connected with the data lines, and data signals are inputted to the pixels for each column through the data lines.

The LCD panel and LCD device of the present invention can avoid the problems such as crosstalk, flicker and the like and thereby improve the display performance by means of improving the pixel arrangement structure of the panel.

In summary, while the present invention has been described preferred embodiments, it is understood that the above-described preferred embodiments are not intended to limit the present invention. One of ordinary skill in the art, without departure from the spirit and scope of the invention, can make various kinds of modifications and variations, and the scope of the present invention is to be defined by the claims.

What is claimed is:

1. An LCD panel comprising:
a plurality of data lines configured for transmitting data signals;
a plurality of scanning lines configured for transmitting scanning signals; and
a plurality of pixel units, each of the pixel units including a plurality of pixels, which have colors including red, green, and blue;
all of the pixels defined by the data lines forming a plurality of pixel columns, or all of the pixels defined by the scanning lines forming a plurality of pixel rows;
wherein all of the pixels in each column have the same color, the pixels with the same color in two adjacent pixel units have opposite polarities, the two adjacent pixels in each pixel unit have opposite polarities, and each of the data lines is connected with the pixels having the same polarity;
when the LCD panel performs a two-dimensional display, a progressive scan for the scanning lines is enabled;
when the LCD panel performs a three-dimensional display, a sequential scan based on orders of groups for the scanning lines being enabled, in which the group for the scanning lines representing a plurality of adjacent scan lines at the rows numbering 2k or a plurality of adjacent scan lines at the rows numbering 2k+1, where k is a positive integer.

2. The LCD panel according to claim 1, wherein the group of the scanning lines represents 2-4 adjacent scan lines at the rows numbering 2k or 2-4 adjacent scan lines at the rows numbering 2k+1.

3. The LCD panel according to claim 1, wherein a refresh rate of the LCD panel is set between 120 Hz and 240 Hz.

4. The LCD panel according to claim 1, wherein the LCD panel further comprises a gate driver chip and a source driver chip, the gate driver chip is connected with the scan lines, through which the scan signals are inputted to the pixels of each row; the source driver chip is connected with the data lines, through which the data signals are inputted to the pixels of each column.

5. The LCD panel according to claim 1, wherein the pixel further comprises a thin film transistor, the scanning line is connected with a control terminal of the thin film transistor of the pixel and the data line is connected with an input terminal of the thin film transistor.

6. An LCD panel comprising:
a plurality of data lines configured for transmitting data signals;
a plurality of scanning lines configured for transmitting scanning signals; and
a plurality of pixel units, each of the pixel units including a plurality of pixels, which have colors including red, green, and blue;
all of the pixels defined by the data lines forming a plurality of pixel columns, or all of the pixels defined by the scanning lines forming a plurality of pixel rows;
wherein all of the pixels in each column have the same color, the pixels with the same color in two adjacent pixel units have opposite polarities, the two adjacent pixels in each pixel unit have opposite polarities, and each of the data lines is connected with the pixels having the same polarity.

7. The LCD panel according to claim 6, wherein a progressive scan for the scanning lines is enabled when the LCD panel performs a two-dimensional display.

8. The LCD panel according to claim 6, wherein when the LCD panel performs a three-dimensional display, a sequential scan based on orders of groups for the scanning lines is enabled, in which the group for the scanning lines represents a plurality of adjacent scan lines at the row numbering 2k or a plurality of adjacent scan lines at the row numbering 2k+1, where k is a positive integer.

9. The LCD panel according to claim 8, wherein the group of the scanning, lines represents 2-4 adjacent scan lines at the row numbering 2k or 2-4 adjacent scan lines at the row numbering 2k+1.

10. The LCD panel according to claim 6, wherein a refresh rate of the LCD panel is set between 120 Hz and 240 Hz.

11. An LCD device comprising:
a backlight module; and
an LCD panel comprising:
a plurality of data lines configured for transmitting data signals;
a plurality of scanning lines configured for transmitting scanning signals; and
a plurality of pixel units, each of the pixel units including a plurality of pixels, which have colors including red, green, and blue;
all of the pixels defined by the data lines forming a plurality of pixel columns, or all of the pixels defined by the scanning lines forming a plurality of pixel rows;
wherein all of the pixels in each column have the same color, the pixels with the same color in two adjacent pixel units have opposite polarities, the two adjacent pixels in each pixel unit have opposite polarities, and each of the data lines is connected with the pixels having the same polarity.

12. The LCD device according to claim 11, wherein a progressive scan for the scanning lines is enabled when the LCD panel performs a two-dimensional display.

13. The LCD device according to claim 11, wherein when the LCD panel performs a three-dimensional display, a sequential scan based on orders of groups for the scanning lines is enabled, in which the group for the scanning lines represents a plurality of adjacent scan lines at the row numbering 2k or a plurality of adjacent scan lines at the row numbering 2k+1, where k is a positive integer.

14. The LCD device according to claim 13, wherein the group of the scanning lines represents 2-4 adjacent scan lines at the row numbering 2k or 2-4 adjacent scan lines at the row numbering 2k+1.

15. The LCD device I according to claim 11, wherein a refresh rate of the LCD panel is set between 120 Hz and 240 Hz.
